(19) United States
(12) Patent Application Publication
(10) Pub. No.: US 2019/0210373 A1
(43) Pub. Date: Jul. 11, 2019

(54) PRINTING UNIT

(71) Applicant: KOENIG & BAUER CODING GMBH, Veitshöchheim (DE)

(72) Inventors: Matthias EILERS, Zellingen (DE); Christoph LEIMEISTER, Würzburg (DE); Frank OTTE, Würzburg (DE); Christian SCHMITT, Eßleben (DE)

(21) Appl. No.: 16/334,451

(22) PCT Filed: Jul. 7, 2017
(86) PCT No.: PCT/EP2017/072401

§ 371 Date: Mar. 19, 2019

(30) Foreign Application Priority Data
Sep. 19, 2016 (DE) 10 2016 217 881.4

(51) Int. Cl. B41J 2/175; B41J 2/165

(52) U.S. Cl. CPC B41J 2/17556; B41J 2/17566; B41J 2/16517; B41J 2/17596

(57) ABSTRACT

A printing unit has at least one supply container for a coating agent, an equalizing container and at least one printing head. The printing unit has a main assembly and a printing head assembly, the supply container being part of the main assembly. The printing head assembly is connected to the main assembly by at least one flexible supply connection. The printing head assembly, as a whole, can be arranged in different printing positions, relative to the main assembly. The printing head assembly has at least one main body, the at least one printing head and at least one nozzle closure. The at least one nozzle closure, and the at least one printing head are movable relative to each other. The nozzle closure has at least one storage element for solvent.

### CROSS REFERENCE TO RELATED APPLICATIONS

This application is the U.S. National Phase, under 35 U.S.C. § 371, of PCT/EP2017/072401, filed Sep. 7, 2017; published as WO 2018/050521 A1 on Mar. 22, 2018, and claiming priority to DE 10 2016 217 881.4, filed Sep. 19, 2016, the disclosures of which are expressly incorporated herein in their entireties by reference.

### FIELD OF THE INVENTION

The present invention relates to a printing system.

### BACKGROUND OF THE INVENTION

Printing systems with print heads are known. Such printing systems typically have systems of lines by which ink can be delivered to the print heads. In particular, systems are known in which pressure ratios within the print head are monitored in order to produce appropriate printing conditions.

US 2012/0176429 A1 discloses a printing system comprising a print head, an ink pump, and a vacuum sensor, with results from the vacuum sensor being used to activate the ink pump.

DE 10 2014 208 896 A1 discloses a printing system in which ink is circulated, and in which a constant ink level is maintained by means of an overflow, and a negative pressure is regulated by means of at least one vacuum regulator connected to a gas line.

US 2008/0273063 A1 discloses a printing system in which ink is circulated and a plurality of tanks are coordinated with one another in terms of their pressures and ink levels.

From EP 1 691 177 A1, a printing system is known which comprises a reservoir, an equalizing tank, a print head, a supply line having a pump or valve between reservoir and equalizing tank, and a print head feed line between equalizing tank and print head. Alternatively, a hydrostatic or an active pressure control system is provided.

Known from DE 602 23 376 T2 is a printing system that draws compressed air from an unspecified source. Ink is transported by compressed air from a reservoir into an equalizing tank. This compressed air can likewise be used to increase the pressure in the equalizing tank in order to clean the nozzles of a print head. A negative pressure in the equalizing tank is generated either by means of the compressed air and a venturi nozzle or by a vacuum pump (not further specified).

EP 0 282 049 A2 discloses a printing system that dispenses with mechanical pumps and instead is connected to a compressed air connection and includes a suction jet pump.

Known from DE 694 25 922 T2 is a printing system for use with hot melt ink, which includes a print head in which a hydrostatic pressure is adjusted by way of the difference between two ink levels. A gas supply pump is used only for print head cleaning. A vacuum pump is used only for bleeding ink.

DE 10 2013 218 952 A1 discloses a printing system to which refill containers can be connected. Said printing system has at least one communications module for wireless communication with data modules of refill containers.

US 2001/0028374 A1 discloses a printing system that comprises a main unit with a reservoir and comprises a print head unit that is connected to the main unit via at least one flexible supply connection and that has a main body, an equalizing tank, and a print head. The print head unit is moved relative to the printing substrate during printing. For cleaning, the print head unit is moved into the active zone of a cleaning device, which can also cover the print head, forming a tight seal.

US 2008/0007579 A1 discloses a printing system that has fixedly arranged print heads. A cleaning device can be moved from below up to the print heads and can cover them, forming a tight seal.

A printing system known from DE 10 2013 217 685 A1 has print heads and cleaning devices that are movable relative to one another.

In a printing system known from JP 2003-341 029 A, the print head is moved relative to the printing substrate and can be moved into an active zone of a cleaning device.

US 2008/174631 A1 and EP 2 033 791 A2 each disclose a printing system in which print heads are supplied with ink via a reservoir and an intermediate store, which are movable vertically and beneath which respective cleaning devices are movable horizontally, and with the cleaning devices having suctioning devices for ink.

US 2015/273907 A1 discloses a printing system in which a print head unit can be moved vertically and horizontally to be placed in contact with a cleaning device.

US 2011/242206 A1 discloses a printing system in which a print head is movable at least horizontally, and a nozzle sealing mechanism is movable vertically, independently of the print head.

EP 2 371 552 A1 and U.S. Pat. No. 9,233,541 B1 and JP H09 109403 A each disclose a printing system in which a print head can be moved vertically, and a nozzle sealing mechanism can be moved independently thereof in a pivoting movement.

WO 2009/047503 A1 discloses a printing system having a variety of lines, containers and pumps.

US 2002/047882 A1 discloses a printing system that has a print head unit that is movable relative to a main unit.

### SUMMARY OF THE INVENTION

The object of the present invention is to provide a printing assembly.

The object is achieved according to the invention by the provision of a printing system which has at least one reservoir for a coating medium, an equalizing tank and at least one print head. The printing system also has a main unit and a print head unit. The reservoir is a component of the main unit. The print head unit is connected to the main unit by at least one flexible supply connection. The print head unit, as a whole, can be arranged in different printing positions relative to the main unit. The print head unit has at least one main body, together with the at least one print head, and at least one nozzle sealing mechanism. The at least one nozzle sealing mechanism and the at least one print head are movable relative to one another. The nozzle sealing mechanism has at least one storage element for a solvent.

A printing system preferably comprises at least one reservoir for coating medium along with an equalizing tank and at least one print head. The at least one print head is preferably fluidically connected to the equalizing tank via at least one print head feed line. The printing system preferably comprises at least one supply line, which extends from the reservoir to the equalizing tank. At least one first pump is preferably positioned along the at least one supply line.

The printing system preferably has a second pump, configured as a gas supply pump, wherein further preferably, the line volume that borders the pump outlet of the second pump passes into the interior chamber of the equalizing tank, without fluidic interruption preferably at least during a printing operation, and more preferably perpetually. This type of junction is without interruption in particular if it is configured without any components that prevent or substantially obstruct a flow, such as at least partially closed shut-off valves, pumps, or the like. The printing system preferably has a third pump, configured as a gas removal pump, wherein further preferably, the line volume that borders the pump inlet of the third pump passes into the interior chamber of the equalizing tank, without fluidic interruption preferably at least during the printing operation and more preferably perpetually. This enables the pressure within the equalizing tank to be measured and preferably controlled or more preferably regulated with particular precision. The printing system is preferably alternatively or additionally characterized by the fact that a first pump volume that can be delivered per pump cycle of the first pump is at least 1 μL and at most 100 μL, and/or in that a second pump volume that can be delivered per pump cycle of the gas supply pump is at least 1 μL and at most 100 μL, and/or in that a third pump volume that can be delivered per pump cycle of the gas removal pump is at least 1 μL and at most 100 μL.

The printing system is preferably alternatively or additionally characterized by the fact that at least one first pressure sensor is positioned so as to measure and/or be capable of measuring a pressure corresponding to the pressure within the equalizing tank, and/or by the fact that a measurement point of the at least one first pressure sensor is fluidically connected without interruption to the interior chamber of the equalizing tank, at least during a printing operation and more preferably perpetually. The lower limit of the measuring range of the at least one first pressure sensor is preferably a negative pressure of at most 50 mbar and/or the upper limit of said measuring range is a positive pressure of at most 50 mbar. The printing system is preferably alternatively or additionally characterized by the fact that at least one second pressure sensor is positioned so as to measure and/or be capable of measuring a pressure corresponding to the pressure within the equalizing tank. The upper limit of the measuring range of the at least one second pressure sensor is preferably a positive pressure of at least 0.3 bar. The printing system is preferably alternatively or additionally characterized by the fact that at least a first shut-off valve is positioned along the print head feed line between the equalizing tank and the print head. The printing system is preferably alternatively or additionally characterized by the fact that at least one fill-level measuring device is positioned in the interior chamber of the equalizing tank so as to measure and/or be capable of measuring the fill level of coating medium. The shut-off valve, in particular in conjunction with the second pressure sensor, facilitates cleaning and/or helps to maintain the functionality of the printing system and/or the pressure ratios during pauses in operations.

The printing system is preferably alternatively or additionally characterized by the fact that at least three and more preferably precisely three pumps embodied as diaphragm pumps are provided, in particular at least three and more preferably precisely three diaphragm pumps per coating medium. A respective pump inlet or pump outlet of these diaphragm pumps is connected without fluidic interruption to the interior chamber of said equalizing tank, for example, directly or via lines, at least during printing operations and more preferably perpetually. This enables a particularly fine metering of coating medium, in particular ink, and/or gas, in particular air, within the equalizing tank and thus particularly constant operating conditions for the at least one print head.

The printing system is preferably alternatively or additionally characterized by the fact that the first pump is embodied as a diaphragm pump and/or in that the gas supply pump is embodied as a diaphragm pump and/or in that the gas removal pump is embodied as a diaphragm pump. The printing system is preferably alternatively or additionally characterized by the fact that an inlet valve that forms a pump inlet of the first pump is configured as a check valve and/or a reed valve, and/or that an outlet valve that forms a pump outlet of the first pump is configured as a check valve and/or a reed valve, and/or that an inlet valve that forms a pump inlet of the second pump is configured as a check valve and/or a reed valve, and/or that an outlet valve that forms the pump outlet of the second pump is configured as a check valve and/or a reed valve, and/or in that an inlet valve that forms the pump inlet of the third pump is configured as a check valve and/or a reed valve, and/or in that an outlet valve that forms a pump outlet of the third pump is configured as a check valve and/or a reed valve.

The printing system is preferably alternatively or additionally characterized by the fact that the printing system comprises a main unit and a print head unit and by the fact that the reservoir is a component of the main unit and by the fact that the at least one print head is a component of the print head unit. The print head unit is preferably connected to the main unit by at least one flexible supply connection. This enables the print head unit to be located in a desirable position relative to the main unit. This is advantageous, for example, because the main unit can be placed in any location and the print head unit can be aligned toward objects and/or printing substrates to be printed. This enables differently shaped objects in different print orders, for example, to be provided with coating medium, for example with an expiration date. The print head unit may also be permanently fixed in place, for example, in which case any orientation is also advantageously possible during installation. The printing system is preferably alternatively or additionally characterized by the fact that the print head unit as a whole can be arranged in different printing positions relative to the main unit. The printing system is preferably alternatively or additionally characterized by the fact that the at least one flexible supply connection is provided as the only component of the printing system that connects the print head unit to the main unit.

The printing system is preferably alternatively or additionally characterized by the fact that the print head unit as a whole can be arranged in at least three, more preferably in at least ten different printing positions relative to the main unit, each of which preferably permits regular printing operation of the printing system, in particular while maintaining the position of the components of the print head unit relative to one another. The at least three and preferably at least ten different printing positions of the print head unit as a whole relative to the main unit preferably differ at least with respect to the ejection direction of nozzles of the at least one print head and with respect to the difference between the height of the lowest point on the bottom of the reservoir and the height of the highest nozzle opening of the at least one print head.

The at least one print head is preferably configured as an inkjet print head. The at least one print head is preferably configured as a print head that remains stationary during a printing operation.

The printing system is preferably alternatively or additionally characterized by the fact that the first pump and/or the gas supply pump and/or the gas removal pump is a component of the main unit. In particular, each of the at least three pumps embodied as diaphragm pumps is a component of the main unit. The printing system is preferably alternatively or additionally characterized by the fact that the at least one supply connection is configured as at least one tube, and/or that at least parts of the supply line and at least parts of a gas supply line and/or a gas removal line and/or a gas equalization line are located in the at least one supply connection, and/or that at least parts of at least one power supply line and/or at least parts of at least one data supply line are located in the at least one supply connection. This enables components that have a relatively large footprint or power or cooling demand to be located in the main unit, allowing the print head unit to be kept as small and flexible as possible. The printing system is preferably alternatively or additionally characterized by the fact that the at least one first pressure sensor is a component of the main unit, and/or by the fact that the at least one second pressure sensor is a component of the main unit.

The printing system is preferably alternatively or additionally characterized by the fact that the print head unit comprises at least one main body and the at least one print head and at least one nozzle sealing mechanism. The printing system is preferably alternatively or additionally characterized by the fact that the at least one nozzle sealing mechanism and the at least one print head are movable relative to one another. This ensures that, regardless of the relative position between print head unit and main unit, the nozzle sealing mechanism is able to cover the nozzle openings of the at least one print head. In particular, the at least one nozzle sealing mechanism is preferably movable, more preferably pivotable, relative to the main body.

The printing system is preferably alternatively or additionally characterized by the fact that the nozzle sealing mechanism has at least one storage element for solvent, more preferably solvent that is different from the coating medium held in the reservoir. This allows an atmosphere to be created that prevents coating medium from drying out and thereby clogging the nozzle openings of the print head. The printing system is preferably alternatively or additionally characterized by the fact that at least one solvent line is connected to the nozzle sealing mechanism, and/or that the nozzle sealing mechanism has at least one sealing element, and/or that the at least one nozzle sealing mechanism is movable, in particular pivotable, relative to the main body between at least one closed position and at least one open position. Sufficient solvent can be perpetually supplied via the solvent line.

The printing system is preferably alternatively or additionally characterized by the fact that the print head unit comprises at least one first subassembly that is movable in particular linearly relative to the main body, and the at least one print head is a component of the first subassembly. This enables a mechanism to be realized in which a movement of the subassembly causes a relative movement between print head and nozzle sealing mechanism.

The printing system is preferably alternatively or additionally characterized by the fact that the printing system has at least one fourth pump, which is preferably different from the at least three diaphragm pumps and/or is designated as a filling pump, and which is positioned along a refill line that ends in a storage space of the reservoir and begins at a coating medium inlet that serves as the connection point for refill containers, and by the fact that the printing system has at least one communications module for wireless communication with data modules of refill containers. This ensures a supply of coating medium that can be processed safely by the printing system, and ensures that enough of such coating medium is always on hand.

In the foregoing and in the following, the term printing fluid includes inks and printing inks, but also varnishes and pasty materials. Printing fluids are preferably materials that are and/or can be transferred by means of a printing machine or a printing system onto a printing substrate, and that thereby create on the printing substrate a texture, preferably in finely structured form and/or not merely over a large area, which texture is preferably visible and/or perceptible by the senses and/or detectable by machine. Inks and printing inks are preferably solutions or dispersions of at least one colorant in at least one solvent. Suitable solvents include water and/or organic solvents, for example. Alternatively or additionally, the printing fluid may be embodied as printing fluid that is cured under UV light. Inks are relatively low-viscosity printing fluids and printing inks are relatively high-viscosity printing fluids. Inks preferably contain no binding agent or relatively little binding agent, whereas printing inks preferably contain a relatively large amount of binding agent, and further preferably contain additional auxiliary agents. Colorants may be pigments and/or dyes, with pigments being insoluble in the application medium, whereas dyes are soluble in the application medium. In particular, inks that contain dyes as colorants preferably have no binder. In the foregoing and in the following, when printing fluids and/or inks and/or printing inks are mentioned, this also includes colorless post-press coatings. In the foregoing and in the following, when printing fluids and/or inks and/or printing inks are mentioned, this also preferably includes, in particular, means for pretreating (precoating) and/or for post-treating (post-coating) the printing substrate. The term coating medium may be understood as synonymous with the term printing fluid.

### BRIEF DESCRIPTION OF THE DRAWINGS

Exemplary embodiments of the invention are illustrated in the set of drawings and will be described in greater detail below.

In the drawings:

FIG. 1 is a schematic diagram of the structure of a printing system and its system of lines;

FIG. 2a is a schematic diagram of a print head unit with a nozzle sealing mechanism disposed in a closed position;

FIG. 2b is a schematic diagram of the print head unit of FIG. 2a with a nozzle sealing mechanism disposed in an open position;

FIG. 3a is a schematic diagram of the nozzle sealing mechanism;

FIG. 3b is a schematic diagram of the interior chamber of the nozzle sealing mechanism according to FIG. 3a;

FIG. 3c is a further schematic diagram of the interior chamber of the nozzle sealing mechanism according to FIG. 3a.

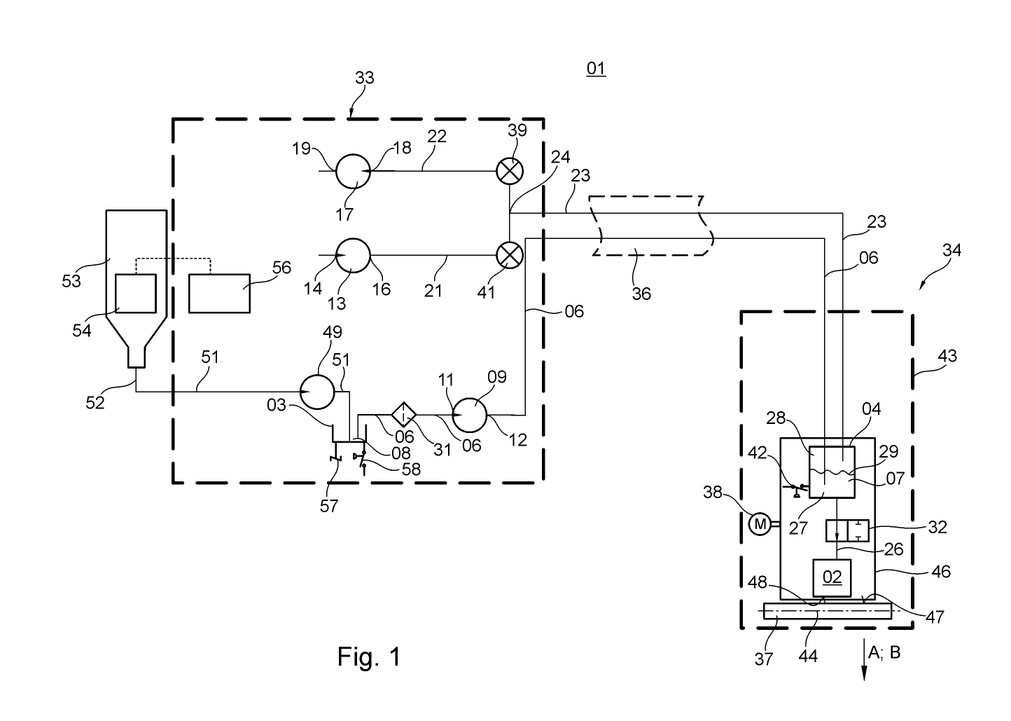

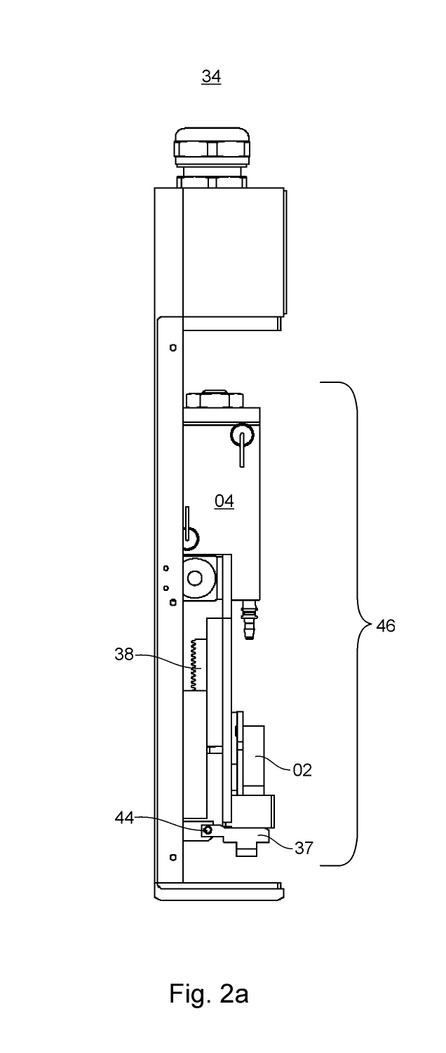

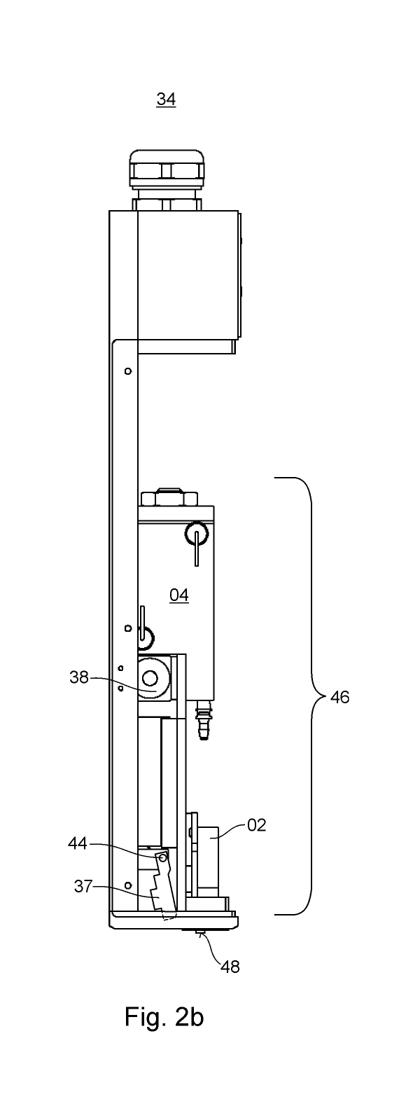

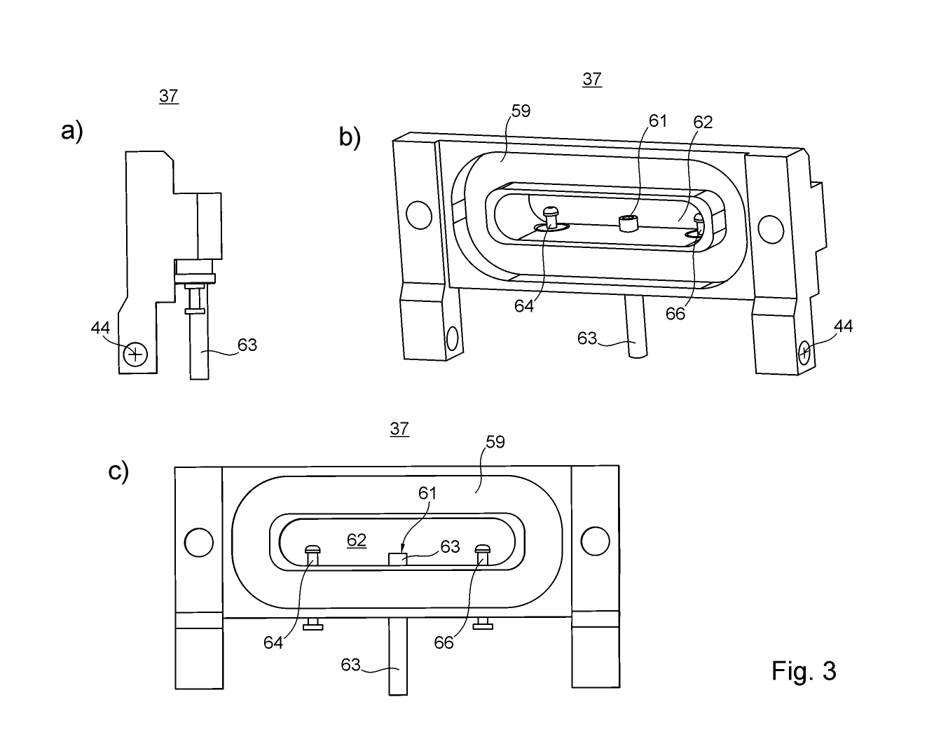

### DESCRIPTION OF PREFERRED EMBODIMENTS

A printing system 01 has at least one print head 02. The at least one print head 02 is preferably configured as an inkjet print head 02. The at least one print head 02 is preferably a print head 02 that remains stationary during a printing operation. The printing system 01 preferably has at least one reservoir 03 for coating medium, in particular ink, and at least one equalizing tank 04. Coating medium or ink is preferably conveyed from the reservoir 03 via the equalizing tank 04 and into the print head 02, and from there is applied as needed to a respective substrate.

The equalizing tank 04 has at least one and preferably precisely one interior chamber 07. The interior chamber 07 of the equalizing tank 04 is intended in particular to hold at least a first liquid volume 27 of coating medium, in particular ink. The interior chamber 07 of the equalizing tank 04 is preferably also intended to hold at least a first gas volume 28. The first gas volume 28 and the first liquid volume 27 of coating medium or ink preferably together fill up the interior chamber 07 of the equalizing tank 04. The at least one print head 02 is preferably fluidically connected via at least one print head feed line 26 to the equalizing tank 04 and in particular to the interior chamber 07 thereof. The print head feed line 26 preferably serves to transport coating medium, in particular ink, from the equalizing tank 04 to the at least one print head 02. Between the equalizing tank 04 at one end and the print head 02 at the other, and in particular along the print head feed line 26, at least one first shut-off valve 32 is preferably arranged.

The print head 02 is preferably a print head 02 that operates by a drop-on-demand method, or a discontinuously operating print head 02. This means that, at least during normal printing operation, droplets of coating medium, in particular ink, are ejected from respective nozzle openings of the print head 02 only when said droplets are assigned to corresponding pixels to be generated. In particular, therefore, these droplets of coating medium, in particular ink, are generated only when they are assigned to corresponding pixels to be generated. (This is in contrast to print heads that continuously eject droplets, some of which are then prevented from reaching the substrate, for example, by electrical charge and selective deflection.) Preferably, only coating medium or ink, and preferably no air or any other gas, is preferably located in the at least one print head 02, at least during a printing operation and preferably also during idle periods.

The print head 02 has nozzle channels that lead to respective nozzle openings. Individual droplets of coating medium or ink are ejected through the nozzle openings as needed. Coating medium, in particular ink, is replenished by means of the nozzle channels. The droplets are preferably ejected by the high-speed reduction of a portion of a respective channel volume of the respective nozzle channel or a portion of a respective chamber volume of a chamber bordering the respective nozzle channel. This reduction in volume forces the coating medium, in particular the ink, out and as a result, a corresponding droplet is ejected from the respective nozzle opening. Thereafter, the corresponding volume is increased again, so that coating medium or ink can flow back in and the process can be repeated. The channel volume or chamber volume is preferably reduced by means of at least one respective droplet-generating element embodied as a piezoelectric element, which changes its dimensions when a voltage is applied to it, and thereby directly alters the corresponding volume. Alternatively, the channel volume or chamber volume is reduced, for example, by means of at least one respective droplet-generating element embodied as a thermocouple, which is heated and thereby vaporizes coating medium, in particular ink, for a short time. The resulting vapor bubble takes up more space than the liquid coating medium from which it was formed, and as a result, the volume available for liquid is indirectly reduced and again, a droplet is ejected.

The reservoir 03 for coating medium, in particular ink, has at least one and preferably precisely one storage space 08. The storage space 08 preferably serves to hold a relatively large amount of coating medium or ink, for example also referred to as reserve volume, for example over an extended period of time. In contrast, the first liquid volume 27 of coating medium or ink held in the equalizing tank 04 serves essentially to ensure that sufficient coating medium or ink is always available in the print head, for example, regardless of where the print head 02 is located.

The print head 02 has at least one and preferably a plurality of nozzle openings. The plurality of nozzle openings are distributed evenly, for example, over a nozzle surface 48 of the print head 02. The coating medium, in particular the ink, is preferably in the form of a liquid column at least in nozzle channels of the print head 02 that adjoin the nozzle openings of the print head 02. The nozzle openings of the print head and/or a surface normal of the nozzle surface 48 of the print head 02 are oriented, for example, in an ejection direction A, at least one component of which preferably points downward. At least during printing operation, the first volume of liquid 27 held in the interior chamber 07 of the equalizing tank 04 preferably passes without any interruption of the liquid into a volume of liquid held in the print head 02, which extends into the nozzle channels and up to respective lower boundaries of said liquid column. The liquid column beginning in the nozzle channels and located partially within the nozzle channels thus preferably extends into the interior chamber 07 of the equalizing tank 04. Between the first liquid volume 27 and the first gas volume 28 is a boundary surface 29, which preferably represents an upper boundary of said liquid column. An upper boundary is understood here as a boundary surface that is located at a higher point with respect to a direction of flow than the nozzle openings and/or that delimits the liquid directly upward, for example, even if portions of the liquid may be located at a higher point in other regions of the system of lines, and even if a corresponding lower boundary may be located at a higher point than said upper boundary. This is the case, for example, when the print head 02 is located above the equalizing tank 04. By way of example, however, the print head 02 is situated at least partially below the equalizing tank 04 and/or the upper boundary is situated above the lower boundary.

Particularly to prevent coating medium or ink from escaping unintentionally through the nozzle openings, a gas pressure in the first gas volume 28 located above the boundary surface 29 is preferably influenced such that the first gas volume 28 is under a slight negative pressure relative to an ambient pressure surrounding the printing system 01, at least during printing operation and preferably also during idle periods. The negative pressure in the first gas volume 28 relative to the ambient pressure is preferably at least 1 mbar (i.e., 100 Pa), more preferably at least 5 mbar (i.e., 500 Pa), and even more preferably at least 10 mbar (i.e., 1000 Pa), and regardless of the minimum value is preferably at most 50 mbar (i.e., 5000 Pa), more preferably at most 25 mbar (i.e., 2500 Pa), and even more preferably at most 15 mbar (i.e., 1500 Pa).

The printing system 01 preferably comprises a system of lines by means of which a fill level within the equalizing tank 04 can be controlled or preferably regulated, and by means of which the gas pressure within the equalizing tank 04 can also be controlled or preferably regulated. In this way, optimized conditions for the print head can be constantly realized.

The printing system 01 comprises at least one and preferably precisely one supply line 06, configured in particular as a liquid supply line 06 and/or coating medium supply line 06 and/or ink supply line 06. The at least one supply line 06 preferably extends from the reservoir 03 to the equalizing tank 04. The at least one supply line 06 is preferably formed as a flexible supply line 06, for example as a supply tube 06. Preferably at least one and more preferably precisely one first pump 09, configured as a coating medium pump 09 and/or ink pump 09, is located along the at least one supply line 06. The first pump 09 has at least one and preferably precisely one first pump inlet 11. The first pump 09 has at least one and preferably precisely one first pump outlet 12. The first pump 09 is preferably connected in terms of circuitry to a machine controller, in particular to a fill-level regulating area of the machine controller.

The pump inlet 11 of the first pump 09, or the first pump inlet 11, is preferably fluidically connected to the reservoir 03. This is realized, for example, by positioning the first pump inlet 11 directly adjacent to the reservoir 03. Alternatively and preferably, however, this is realized by connecting the first pump inlet 11 to the reservoir 03 via a segment of the supply line 06. Along this segment of the supply line 06, at least one filter device 31 is arranged, for example.

The pump outlet 12 of the first pump 09, or the first pump outlet 12, is preferably fluidically connected to the interior chamber 07 of the equalizing tank 04. This is realized, for example, by positioning the equalizing tank 04 directly adjacent to the first pump outlet 12. Alternatively and preferably, however, this is realized by connecting the equalizing tank 04 to the first pump outlet 12 via a segment of the supply line 06. The at least one supply line 06 ends, for example, below the boundary surface 29 between the first liquid volume 27 and the first gas volume 28, and more preferably ends below the position at a lower indicator level of the boundary surface 29 between the first liquid volume 27 and the first gas volume 28.

Preferably, at least one and more preferably precisely one second pump 13 configured as a gas supply pump 13 is provided. The second pump 13 has at least one and preferably precisely one second pump inlet 14. The second pump 13 has at least one and preferably precisely one second pump outlet 16. The second pump 13 is preferably connected in terms of circuitry to the machine controller, in particular to a pressure regulating area of the machine controller.

The pump outlet 16 of the gas supply pump 13, or the second pump outlet 16, is preferably fluidically connected to the interior chamber 07 of the equalizing tank 04, for example directly or via at least one gas supply line 21 and/or via a gas equalization line 23. Preferably, a line volume bordering the second pump outlet 16 passes into the interior chamber 07 of the equalizing tank 04, in particular without interruption at least during printing operation, and more preferably perpetually without interruption. Whether or not this line volume is limited by the gas supply line 21 or the gas equalization line 23 is irrelevant, as long as no element that interrupts the line volume is present.

Preferably at least one and more preferably precisely one third pump 17 configured as a gas removal pump 17 is provided. The third pump 17 has at least one and preferably precisely one third pump inlet 18. The third pump 17 has at least one and preferably precisely one third pump outlet 19. The third pump 17 is preferably connected in terms of circuitry to the machine controller, in particular to the pressure regulating area of the machine controller.

The pump inlet 18 of the gas removal pump 17, or the third pump inlet 18, is preferably fluidically connected to the interior chamber 07 of the equalizing tank 04, for example directly or via at least one gas removal line 22 and/or via a gas equalization line 23. Preferably, a line volume bordering the second pump inlet 18 passes into the interior chamber 07 of the equalizing tank 04, in particular without interruption at least during printing operation, and more preferably perpetually without interruption. Whether or not this line volume is limited by the gas removal line 22 or the gas equalization line 23 is irrelevant, as long as no element that interrupts the line volume is present.

In a first embodiment of a pressure equalizing system, a gas supply line 21 is connected at one end to the second pump outlet 16 and at the other end to the interior chamber 07 of the equalizing tank 04, and a gas removal line 22 that is distinct from the gas supply line 21 is connected at one end to the third pump inlet 18 and at the other end to the interior chamber 07 of the equalizing tank 04. In a preferred second embodiment of the pressure equalizing system, a gas equalization line 23 is provided, which is fluidically connected at one end to the interior chamber 07 of the equalizing tank 04 and which is fluidically connected at the other end to both a gas supply line 21 and a gas removal line 22, said gas supply line 21 in turn being fluidically connected to the second pump outlet 16 and said gas removal line 22 in turn being fluidically connected to the third pump inlet 18. The gas supply line 21 and the gas removal line 22 and the gas equalization line 23 then preferably meet at a common intersection point 24.

The printing system 01 preferably comprises at least a first unit 33 and a second unit 34. The first unit 33 of the printing system 01 is preferably configured as a main unit 33. The second unit 34 of the printing system 01 is preferably configured as a print head unit 34. The first main unit 33 preferably occupies a first volume of space that is larger than a second volume of space occupied by the second unit 34, for example at least twice as large, more preferably at least five times as large, and even more preferably at least ten times as large. The print head unit 34 and/or the components 02; 04; 06; 32; 37; 38; 42 assigned to the print head unit 34 are preferably movable relative to the main unit 33 and/or to the components 03; 09; 13; 17; 31; 39; 41; 49; 51; 52; 56; 57; 58 assigned to the main unit 33, and/or can be arranged in different positions relative to the main unit 33 and/or to the components 03; 09; 13; 17; 31; 39; 41; 49; 51; 52; 56; 57; 58 assigned to the main unit 33. In particular, this enables the print head 02 to be flexibly positioned and/or repeatedly repositioned, while the main unit 33 and thus preferably the majority of the mass and/or the majority of the volume of the printing system 01 can remain stationary and/or separated from confined areas and/or easily accessible to operators.

The print head unit 34 preferably is and/or can be connected to the main unit 33 via at least one flexible supply connection 36. The at least one supply connection 36 is configured, for example, as at least one tube 36. At least portions of the supply line 06 or liquid supply line 06 are preferably located in the at least one supply connection 36. At least portions of the gas supply line 21 and/or at least portions of the gas removal line 22 and/or more preferably at least portions of the gas equalization line 23 are preferably located in the at least one supply connection 36. At least portions of at least one power supply line and/or at least portions of at least one data supply line are preferably located in the at least one supply connection 36. The at least one gas supply line 21 is preferably configured as a flexible gas supply line 21, in particular as a gas supply tube 21. The at least one gas removal line 22 is preferably configured as a flexible gas removal line 22, in particular as a gas removal tube 22. The at least one gas equalization line 23 is preferably configured as a flexible gas equalization line 23, in particular as a gas equalization tube 23.

Preferably, at least the print head 02 is configured as a component 02 of the print head unit 34 and/or the equalizing tank 04 is configured as a component 04 of the print head unit 34 and/or the supply line 06 is configured as a component 06 of the print head unit 34 and/or the first shut-off valve 32 is configured as a component 32 of the print head unit 34 and/or at least one nozzle sealing mechanism 37 is configured as a component 37 of the print head unit 34 and/or at least one nozzle sealing drive 38 and/or positioning drive 38 is configured as a component 38 of the print head unit 34.

Preferably, at least the first pump 09 is configured as a component 09 of the main unit 33 and/or the second pump 13 is configured as a component 13 of the main unit 33 and/or the third pump 17 is configured as a component 17 of the main unit 33 and/or the reservoir 03 is configured as a component 03 of the main unit 33 and/or the filter device 31 is configured as a component 31 of the main unit 33.

The first pump 09 is preferably configured as a diaphragm pump 09. The first pump 09 preferably has a first pump interior chamber. The interior chamber of the first pump is preferably bounded on the inlet side by a first inlet valve. The first inlet valve preferably forms the first pump inlet 11. The first inlet valve is preferably configured as a check valve, in particular as a check valve and/or reed valve that permits fluid to flow into the interior chamber of the first pump. The interior chamber of the first pump is preferably bounded on the outlet side by a first outlet valve. The first outlet valve preferably forms the first pump outlet 12. The first outlet valve is preferably configured as a check valve, in particular as a check valve and/or reed valve that permits fluid to flow out of the interior chamber of the first pump. Apart from the first inlet valve and the first outlet valve, the interior chamber of the first pump is preferably enclosed by an at least partially flexible first outer shell. The first outer shell is preferably at least partially formed by at least one in particular impermeable flexible membrane.

The first pump 09 preferably has at least one first stroke element or armature. The first stroke element is preferably movable, in particular linearly movable, by means of a first pump drive. The first pump 09 is preferably configured as a linear pump. The first stroke element is preferably movable between at least one maximum position and one minimum position, wherein when the first stroke element is in the maximum position, the interior chamber of the first pump has a maximum first inner volume, and wherein when the first stroke element is in the minimum position, the interior chamber of the first pump has a minimum first inner volume, and in particular wherein the minimum first inner volume is smaller than the maximum first inner volume. A movement of the first stroke element from the maximum position to the minimum position is called an expelling movement of the first stroke element. During the expelling movement of the first stroke element, the first inner volume is reduced. This creates an overpressure in the interior chamber of the first pump. Fluid located therein, in particular coating medium or ink, is expelled through the first outlet valve. The first inlet valve remains closed by virtue of the pressure conditions. A movement of the first stroke element from the minimum position to the maximum position is called a suctioning movement of the first stroke element. During the suctioning movement of the first stroke element, the first inner volume is enlarged. This creates a negative pressure in the interior chamber of the first pump. Fluid, in particular coating medium or ink, located in front of the first inlet valve is suctioned in through the first inlet valve and is conveyed into the interior chamber of the first pump. The first outlet valve remains closed by virtue of the pressure conditions.

One pump cycle preferably consists of one suctioning movement and one subsequent expelling movement. With each pump cycle of the first pump 09, a first pump volume is delivered, in particular from upstream of the first pump inlet 11 to downstream of the first pump outlet 12. The first pump volume is dependent upon the geometric ratios of the first pump 09, in particular the dimensions thereof, but also upon the first stroke height of the first piston. This first stroke height preferably refers to the distance covered by the first piston between its minimum position and its maximum position. The first pump drive is configured as a magnetic first pump drive, for example. Preferably, a first coil is provided, which exerts a force corresponding to the flow of current on the first stroke element, and in interaction with a restoring element, for example, moves said stroke element into a certain position, in particular either the minimum position or the maximum position. A restoring element is provided, for example, which forces the first stroke element into a neutral position. The neutral position is the maximum position, for example. Preferably, however, the neutral position is the minimum position. More preferably, when the first stroke element is in the minimum position and preferably also the neutral position, the interior chamber of the first pump and/or every flow path extending from the inlet valve of the first pump 09 to the outlet valve of the first pump 09 is completely sealed. In said position, no fluid can pass through the interior chamber of the first pump, independently of the inlet valve and the outlet valve.

The first pump volume can preferably be selected up to a maximum pump volume that is predetermined by the geometric ratios, in particular by means of a mechanical stop, which can limit the maximum position accordingly. The first pump volume is preferably at least 1 μL (one microliter), more preferably at least 7 μL (seven microliters), and even more preferably at least 15 μL (fifteen microliters). Regardless of the minimum, the first pump volume is preferably at most 100 μL (one hundred microliters), more preferably at most 50 μL (fifty microliters), and even more preferably at most 25 μL (twenty-five microliters). Depending upon the amount to be delivered, an appropriate number of pump cycles is preferably carried out. Preferably at least ten, and more preferably at least fifteen pump cycles per second can be carried out by the first pump 09.

The second pump 13 is preferably similar in configuration to the first pump 09. The second pump 13 is preferably configured as a diaphragm pump 13. The second pump 13 preferably has a second pump interior chamber. The interior chamber of the second pump is preferably bounded on the inlet side by a second inlet valve. The second inlet valve preferably forms the second pump inlet 14. The second inlet valve is preferably configured as a check valve, in particular as a check valve and/or reed valve that permits fluid to flow into the interior chamber of the second pump. The interior chamber of the second pump is preferably bounded on the outlet side by a second outlet valve. The second outlet valve preferably forms the second pump outlet 16. The second outlet valve is preferably configured as a check valve, in particular as a check valve and/or reed valve that permits fluid to flow out of the interior chamber of the second pump. Apart from the second inlet valve and the second outlet valve, the interior chamber of the second pump is preferably enclosed by an at least partially flexible second outer shell. The second outer shell is preferably at least partially formed by at least one in particular impermeable flexible membrane. The second pump 13 preferably has at least one second stroke element or armature. The second stroke element is preferably movable, in particular linearly movable, by means of a second pump drive. The second pump 13 is preferably configured as a linear pump. The second stroke element is preferably movable between at least one maximum position and one minimum position, wherein when the second stroke element is in the maximum position, the interior chamber of the second pump has a maximum second inner volume, and wherein when the second stroke element is in the minimum position, the interior chamber of the second pump has a minimum second inner volume, and in particular wherein the minimum second inner volume is smaller than the maximum second inner volume.

With regard to the movements of the second stroke element between maximum position and minimum position, the above statements referring to the first pump 09 and the first stroke element thereof preferably apply accordingly. With each pump cycle of the second pump 13, a second pump volume is delivered, in particular from upstream of the second pump inlet 14 to downstream of the second pump outlet 16. The second pump volume is dependent upon the geometric ratios of the second pump 13, in particular upon the dimensions thereof, but also upon the second stroke height of the second piston. The second pump drive is preferably similar in configuration to the first pump drive. Preferably, when the second stroke element is in the neutral position or minimum position, the interior chamber of the second pump and/or every flow path extending from the inlet valve of the second pump 13 to the outlet valve of the second pump 13 is completely sealed. In said position, no fluid can pass through the interior chamber of the second pump, independently of the inlet valve and the outlet valve. The second pump volume is preferably at least 1 μL (one microliter), more preferably at least 7 μL (seven microliters), and even more preferably at least 15 μL (fifteen microliters). Regardless of the minimum, the second pump volume is preferably at most 100 μL (one hundred microliters), more preferably at most 50 μL (fifty microliters), and even more preferably at most 25 μL (twenty-five microliters). Depending upon the amount to be delivered, an appropriate number of pump cycles is preferably carried out. Preferably at least ten, and more preferably at least fifteen pump cycles per second can be carried out by the second pump 13.

The third pump 17 is preferably similar in configuration to the first pump 09. Alternatively or additionally, the third pump 17 is preferably similar in configuration to the second pump 09. The third pump 17 is preferably configured as a diaphragm pump 17. The third pump 17 preferably has a third pump interior chamber. The interior chamber of the third pump is preferably bounded on the inlet side by a third inlet valve. The third inlet valve preferably forms the third pump inlet 18. The third inlet valve is preferably configured as a check valve, in particular as a check valve and/or reed valve that permits fluid to flow into the interior chamber of the third pump. The interior chamber of the third pump is preferably bounded on the outlet side by a third outlet valve. The third outlet valve preferably forms the third pump outlet 19. The third outlet valve is preferably configured as a check valve, in particular as a check valve and/or reed valve that permits fluid to flow out of the interior chamber of the third pump. Apart from the third inlet valve and the third outlet valve, the interior chamber of the third pump is preferably enclosed by an at least partially flexible third outer shell. The third outer shell is preferably at least partially formed by at least one in particular impermeable flexible membrane. The third pump 17 preferably has at least one third stroke element or armature. The third stroke element is preferably movable, in particular linearly movable, by means of a third pump drive. The third pump 17 is preferably configured as a linear pump. The third stroke element is preferably movable between at least one maximum position and one minimum position, wherein when the third stroke element is in the maximum position, the interior chamber of the third pump has a maximum third inner volume, and wherein when the third stroke element is in the minimum position, the interior chamber of the third pump has a minimum third inner volume, and in particular wherein the minimum third inner volume is smaller than the maximum third inner volume.

With regard to the movements of the third stroke element between maximum position and minimum position, the above statements referring to the first pump 09 and the first stroke element thereof preferably apply accordingly. With each pump cycle of the third pump 17, a third pump volume is delivered, in particular from upstream of the third pump inlet 18 to downstream of the third pump outlet 19. The third pump volume is dependent upon the geometric ratios of the third pump 17, in particular upon the dimensions thereof, but also upon the third stroke height of the third piston. The third pump drive is preferably similar in configuration to the first pump drive. Preferably, when the third stroke element is in the neutral position or minimum position, the interior chamber of the third pump and/or every flow path extending from the inlet valve of the third pump 17 to the outlet valve of the third pump 17 is completely sealed. In said position, no fluid can pass through the interior chamber of the third pump, independently of the inlet valve and the outlet valve. The third pump volume is preferably at least 1 μL (one microliter), more preferably at least 7 μL (seven microliters), and even more preferably at least 15 μL (fifteen microliters). Regardless of the minimum, the third pump volume is preferably at most 100 μL (one hundred microliters), more preferably at most 50 μL (fifty microliters), and even more preferably at most 25 μL (twenty-five microliters). Depending upon the amount to be delivered, an appropriate number of pump cycles is preferably carried out. Preferably at least ten, and more preferably at least fifteen pump cycles per second can be carried out by the third pump 17.

The printing system 01 preferably comprises at least one first fill-level measuring device 42. The first fill-level measuring device 42 is preferably used to measure a first fill level of coating medium, in particular ink, in the interior chamber 07 of the equalizing tank 04. The at least one first fill-level measuring device 42 is therefore preferably positioned so as to measure and/or be capable of measuring the fill level of coating medium, in particular ink, in the interior chamber 07 of the equalizing tank 04. This first fill level represents in particular a measure of the first liquid volume 27 held in the equalizing tank 04. The first fill-level measuring device 42 is preferably a component 42 of the print head unit 34. Preferably, at least one piece of information about the lower indicator level of the equalizing tank 04 and one piece of information about an upper indicator level of the equalizing tank 04 can be detected by the first fill-level measuring device 42. The lower indicator level of the equalizing tank 04 corresponds in particular to a lower fill level of the equalizing tank 04 than the upper indicator level of the equalizing tank 04. The first liquid volume 27 corresponding to the lower indicator level is at least 5 mL, more preferably at least 8 mL, and/or is at most 90 mL, more preferably at most 50 mL and even more preferably at most 20 mL, for example. The first liquid volume 27 corresponding to the upper indicator level is at least 8 mL, more preferably at least 10 mL, and/or is at most 100 mL, more preferably at most 60 mL, and even more preferably at most 25 mL, for example. The first liquid volume 27 corresponding to the upper indicator level is about 20% greater than the first liquid volume 27 corresponding to the lower indicator level, for example.

In one embodiment, the first fill-level measuring device 42 has a sensor which is suitable for determining whether the fill level of the equalizing tank 04 has reached the lower indicator level of the equalizing tank 04 and is also suitable for determining whether the fill level of the equalizing tank 04 has reached the upper indicator level of the equalizing tank 04. In an alternative embodiment, the first fill-level measuring device 42 has a first sensor which is suitable for determining whether the fill level of the equalizing tank 04 has reached the lower indicator level of the equalizing tank 04, and the first fill-level measuring device 42 has a second sensor which is suitable for determining whether the fill level of the equalizing tank 04 has reached the upper indicator level of the equalizing tank 04. The first fill-level measuring device 42 is preferably connected in terms of circuitry to the machine controller, in particular to the fill-level regulating area of the machine controller.

By means of the fill-level measuring device 42, the amount of coating medium or ink held in the equalizing tank 04 is preferably monitored. Information supplied by the fill-level measuring device 42 is preferably used to control or more particularly to regulate the quantity of coating medium or ink that is held in the equalizing tank 04. For example, in a filling process the first pump 09 is activated first and delivers coating medium or ink, in particular from the reservoir 03 into the equalizing tank 04, in particular until the first liquid volume 27 is high enough that the upper indicator level is reached. When the upper indicator level is reached, the fill-level measuring device 42 generates a signal, on the basis of which the first pump 09 is preferably first deactivated. In a removal procedure and in particular during printing operation, coating medium, in particular ink, is then removed from the equalizing tank 04 by the ejection of droplets from the nozzle openings, in particular such that the first liquid volume 27 held in the equalizing tank decreases. As soon as the first liquid volume 27 in the equalizing tank 04 has decreased enough to reach the lower indicator level, the fill-level measuring device 42 generates a signal, on the basis of which the first pump 09 is preferably reactivated. This begins another filling process, which in turn ends when the upper indicator level is reached.

At least intermittently during the filling process, for example, the printing operation is carried out. At those times coating medium, in particular ink, is simultaneously supplied to and removed from the equalizing tank 04. The first pump 09 is preferably configured such that it can deliver more coating medium or ink per unit of time than the print head 02 can eject per unit of time, even with all of its droplet generating elements operating constantly. This ensures that the equalizing tank 04 cannot unintentionally run dry. In particular, the filling process and the removal process then at least intermittently take place simultaneously.

In one variant of the regulation of the amount of coating medium or ink contained in the equalizing tank 04, after the upper indicator level has been reached and after a coating medium, in particular ink, has subsequently been removed, but before the lower indicator level is reached, coating medium, in particular ink, is delivered at regular or irregular intervals from the reservoir 03 to the equalizing tank 04, at least until the upper indicator level is reached again. This causes the quantity of coating medium or ink in the equalizing tank 04 to decrease more slowly. In a preferred variant of the regulation of the quantity of coating medium or ink contained in the equalizing tank 04, activation of the first pump 09 is made dependent upon reaching the lower fill level and deactivation of the first pump 09 is made dependent upon reaching the upper fill level, as described above.

At least one first pressure sensor 39 is preferably provided. The at least one first pressure sensor 39 preferably measures the pressure prevailing in the first gas volume 28 in the interior chamber 07 of the equalizing tank 04, in particular during a printing operation and/or when the printing system 01 is idle. When the printing system 01 is idle, the first shut-off valve 32 is preferably at least intermittently closed. The at least one first pressure sensor 39 is thus located, for example, at least partially in the interior chamber 07 of the equalizing tank 04. Preferably, however, the at least one first pressure sensor 39 is connected indirectly to the interior chamber 07 of the equalizing tank 04. Preferably, the at least one first pressure sensor 39 is positioned along the gas supply line 21 and/or along the gas removal line 22 and/or along the gas equalization line 23. The line volume of the gas supply line 21 and/or of the gas removal line 22 and/or of the gas equalization line 23 is preferably connected without interruption to the interior chamber 07 of the equalizing tank 04. In this way, the pressure prevailing in the interior chamber 07 of the equalizing tank 04 can also be measured within the gas supply line 21 and/or the gas removal line 22 and/or the gas equalization line 23. For example, the at least one first pressure sensor 39 is positioned along the gas removal line 22, which is located between the common intersection point 24 and the pump inlet 18 of the gas removal pump 17. In particular, the at least one first pressure sensor 39 is positioned so as to measure and/or be capable of measuring a pressure that corresponds to the pressure within the equalizing tank 04. Preferably, a measurement point of the at least one first pressure sensor 39 is fluidically connected without interruption, at least during a printing operation and more preferably perpetually, to the interior chamber 07 of the equalizing tank 04.

The at least one first pressure sensor 39 is preferably a vacuum sensor 39. The at least one first pressure sensor 39 preferably serves to determine the negative pressure in the first gas volume 28 relative to the ambient pressure. The lower limit of the measuring range of the at least one first pressure sensor 39 is preferably a negative pressure of at most 50 mbar (i.e., 5000 Pa), more preferably at most 35 mbar (i.e., 3500 Pa), and even more preferably at most 22 mbar (i.e., 2200 Pa). Regardless of the lower limit, the upper limit of the measuring range of the at least one first pressure sensor 39 is preferably a positive pressure of at most 50 mbar (i.e., 5000 Pa), more preferably at most 35 mbar (i.e., 3500 Pa), and even more preferably at most 18 mbar (i.e., 1800 Pa). The measuring range is the range of measurable values for the difference between the pressure within the range to be measured and the ambient pressure or atmospheric pressure. The at least one first pressure sensor 39 is preferably connected in terms of circuitry to the machine controller, in particular to the pressure regulating area of the machine controller. The first pressure sensor 39 is preferably a component 39 of the main unit 33.

The volume of the interior chamber 07 of the equalizing tank 04 is preferably substantially and more preferably fully constant. Therefore, in particular with a change in the quantity of coating medium or ink contained in the equalizing tank 04 and thus a change in the first liquid volume 27, the first gas volume 28, which is likewise contained in particular in the equalizing tank 04, is likewise changed. If the quantity of gas in this first gas volume 28 were to remain constant, in particular by the number of corresponding molecules remaining unchanged, then the pressure would be changed. As the first liquid volume 27 decreases, the first gas volume 28 would increase and therefore, the pressure in the first gas volume 28 would decrease. Conversely, as the first liquid volume 27 increases, the first gas volume 28 would decrease and therefore, the pressure in the first gas volume 28 would increase. However, under certain circumstances this would have an undesirable effect on the negative pressure prevailing in the first gas volume 28 in relation to the ambient pressure and thus would undesirably impact the behavior of the coating medium, in particular the ink, in the region of the nozzle channels and/or the nozzle openings and/or with respect to an emergence of the coating medium, in particular the ink, from the nozzle openings.

Therefore, the pressure in the first gas volume 28 is preferably controlled and more preferably regulated. The negative pressure in the first gas volume 28 is measured relative to an ambient pressure by means of the at least one first pressure sensor 39. As described, this can also be performed outside of the equalizing tank 04, as long as there is a direct fluidic connection. If the pressure measured in the first gas volume 28 is too low and/or if a negative pressure measured in the first gas volume 28 relative to the ambient pressure is too high, the second pump 13 will be activated at least briefly and will deliver gas, in particular air, from its pump inlet 14 to its pump outlet 16 and in particular into the gas supply line 21 and/or into the gas equalization line 23 and/or into the interior chamber 07 of the equalizing tank 04, but in any case preferably into a region that is fluidically connected directly to the first gas volume 28. The quantity of gas in the first gas volume 28 is thereby increased, and thus the pressure in the first gas volume 28 is increased and/or the amount of negative pressure is reduced. If the pressure measured in the first gas volume 28 is too high and/or if a negative pressure measured in the first gas volume 28 relative to the ambient pressure is too low, the third pump 17 will be activated at least briefly and will deliver gas, in particular air, from its pump inlet 18 to its pump outlet 19 and in particular out of the gas removal line 22 and/or out of the gas equalization line 23 and/or out of the interior chamber 07 of the equalizing tank 04, but in any case preferably out of a region that is fluidically connected directly to the first gas volume 28. The quantity of gas in the first gas volume 28 is thereby reduced, and thus the pressure in the first gas volume 28 is reduced and/or the amount of negative pressure is increased.

In this way, the pressure in the interior chamber 07 of the equalizing tank 04 and/or the negative pressure in the first gas volume 27 can be kept substantially constant relative to an ambient pressure. The conditions for an ejection of droplets of the coating medium, in particular the ink, are thereby preferably kept substantially constant, in particular independently of the fill level of the equalizing tank 04 and/or independently of the first liquid volume 27. The negative pressure in the first gas volume 27 relative to an ambient pressure is preferably regulated independently of the relative positioning height between the print head 02 and the main unit 33. A particularly flexible positioning of the print head 02 is possible as a result. This is supported by the fact that the equalizing tank 04 is always positioned and/or movable together with the print head 02.

The first liquid volume of coating medium or ink contained in the equalizing tank 04 is preferably controlled or more particularly regulated without the use of signals from the at least one first pressure sensor 39. The pressure in the first gas volume 28 is preferably controlled and/or regulated without the use of signals from the at least one first fill-level measuring device 42. In particular, the first liquid volume of coating medium or ink contained in the equalizing tank 04 is preferably controlled or more particularly regulated to this extent independently of and/or separately from the control or more particularly the regulation of the pressure in the first gas volume 28. A relationship exists only indirectly, because the changing fill level influences the pressure in the first gas volume 27.

At least one second pressure sensor 41 is preferably provided. The at least one second pressure sensor 41 preferably measures the pressure prevailing in the first gas volume 28 in the interior chamber 07 of the equalizing tank 04, in particular during at least part of a cleaning process. The at least one second pressure sensor 41 is thus located, for example, at least partially in the interior chamber 07 of the equalizing tank 04. Preferably, however, the at least one second pressure sensor 41 is connected indirectly to the interior chamber 07 of the equalizing tank 04. The at least one second pressure sensor 41 is preferably positioned along the gas supply line 21 and/or along the gas removal line 22 and/or along the gas equalization line 23. The line volume of the gas supply line 21 and/or of the gas removal line 22 and/or of the gas equalization line 23 is preferably connected without interruption to the interior chamber 07 of the equalizing tank 04, as described above. This enables the pressure prevailing in the interior chamber 07 of the equalizing tank 04 to also be measured within the gas supply line 21 and/or the gas removal line 22 and/or the gas equalization line 23. For example, the at least one second pressure sensor 41 is positioned along the gas supply line 21, which is located between the common intersection point 24 and the pump outlet 16 of the gas supply pump 13. In particular, the at least one second pressure sensor 41 is positioned so as to measure and/or be capable of measuring a pressure that corresponds to the pressure within the equalizing tank 04. Preferably, a measurement point of the at least one second pressure sensor 41 is fluidically connected without interruption, at least during the printing operation and more preferably perpetually, to the interior chamber 07 of the equalizing tank 04.

The at least one second pressure sensor 41 is preferably an overpressure sensor 41. The at least one second pressure sensor 41 preferably serves to determine the overpressure in the first gas volume 28 relative to the ambient pressure. The lower limit of the measuring range of the at least one second pressure sensor 41 is preferably a pressure of 0 mbar. In particular, the lower limit of the measuring range of the at least one second pressure sensor 41 is preferably within the measuring range of the at least one first pressure sensor 39. Regardless of the lower limit, the upper limit of the measuring range of the at least one second pressure sensor 41 is preferably a positive pressure of at most 2.5 bar (i.e., 250 kPa), more preferably at most 1.8 bar (i.e., 180 kPa), and even more preferably at most 1.1 bar (i.e., 110 kPa). Regardless of the lower limit, the upper limit of the measuring range of the at least one second pressure sensor 41 is preferably a positive pressure of at least 0.3 bar (i.e., 30 kPa), more preferably at least 0.5 bar (i.e., 50 kPa), and even more preferably at least 0.8 bar (i.e., 80 kPa). The measuring range is the range of measurable values for the difference between the pressure within the range to be measured and the ambient pressure or atmospheric pressure. The at least one second pressure sensor 41 is preferably connected in terms of circuitry to the machine controller, in particular to the pressure regulating area of the machine controller. The second pressure sensor 41 is preferably a component 41 of the main unit 33.

In the following, two cleaning processes will be described. Preferably, at least one of the cleaning processes is used, or both cleaning processes are used in succession, depending upon the situation. In a first cleaning process, the droplet generating elements of the print head remain unchanged. The pressure in the interior chamber 07 of the equalizing tank 04 is increased in relation to the conditions of the printing operation. At least a negative pressure is thereby reduced in relation to the ambient pressure or is reduced to zero. It is even possible for an overpressure in relation to the ambient pressure to be generated in the interior chamber 07 of the equalizing tank 04. The coating medium, in particular the ink, that was previously held back by the negative pressure in the nozzle channels then passes from the nozzle openings, in particular from all the nozzle openings, by virtue of gravity and/or the overpressure. This allows soil and dried-up particles to be flushed out.

In a second cleaning process, the first shut-off valve 32 is preferably first closed. The pressure in the interior chamber 07 of the equalizing tank 04 is then increased. This is preferably accomplished by delivering additional coating medium, in particular additional ink, to the interior chamber 07 of the equalizing tank 04, in particular by means of the first pump 09, and/or by delivering additional gas, in particular additional air, to the interior chamber 07 of the equalizing tank 04, in particularly by means of the second pump 13. For example, additional ink is first delivered to the interior chamber 07 of the equalizing tank 04 until a certain fill level, in particular the upper indicator level, and/or a certain pressure within the first gas volume 28 is reached, after which additional gas, in particular additional air, is delivered to the interior chamber 07 of the equalizing tank 04 until a cleaning overpressure within the first gas volume relative to the ambient pressure is reached. The first shut-off valve 32 is then preferably opened at least briefly. Coating medium, in particular ink, is thereby accelerated and forced out of the nozzle openings at high speed. As a result, any air bubbles that are present within the print head 02, in particular within the nozzle channels, are preferably carried along and conveyed out through the nozzle openings. Afterward, medium preferably flows through all of the nozzle openings in that all of the droplet-generating elements are activated at least once and more preferably multiple times in succession, and thus defined droplets are ejected.

The printing system 01 preferably has at least one nozzle sealing mechanism 37. The at least one nozzle sealing mechanism 37 preferably serves to seal the nozzle surface 48 and/or the nozzle openings of the print head 02 off from a surrounding area, for example to provide mechanical protection and/or to prevent coating medium, in particular ink, that is held in the nozzle channels from drying out and thereby potentially clogging said nozzle openings and/or rendering said openings unusable. At least one sealing mechanism drive 38 is preferably provided, by means of which the at least one print head 02, in particular the nozzle surface 48 thereof, and the at least one nozzle sealing mechanism 37 can be moved relative to one another. For example, the at least one nozzle sealing mechanism 37 is pivotable about a pivot axis 44. At least one restoring element is preferably provided, which creates a restoring force that forces the at least one nozzle sealing mechanism 37 into a home position. The home position is preferably a closed position in which the at least one nozzle sealing mechanism 37 seals off the nozzle surface 48 and/or the seals the nozzle openings of the print head 02 off from the surrounding environment. In that case, the at least one sealing mechanism drive 38 is preferably configured such that the at least one sealing mechanism drive 38 can move the at least one nozzle sealing mechanism 37 to a position other than the home position, in particular to an open position, in which the at least one nozzle sealing mechanism 37 opens up the nozzle surface 48 and/or the nozzle openings of the print head 02, in particular with respect to the ejection direction A.

In a preferred embodiment, the print head unit 34 comprises at least one main body 43. The at least one nozzle sealing mechanism 37 is preferably movable, for example pivotable, relative to the main body 43, and in particular is pivotable about the pivot axis 44. A pivoting space is preferably a spatial area which is made up of the total of all the spatial areas that can be occupied by the at least one nozzle sealing mechanism 37 along its pivot path about the pivot axis 44. The print head unit 34 preferably comprises at least one first subassembly 46. The first subassembly 46 is preferably movable relative to the main body 43 of the print head unit 34, in particular linearly movable and/or movable along a positioning path. The first subassembly 46 is preferably movable, in particular linearly movable, relative to the main body 43 of the print head unit 34 by means of a positioning drive 38. The print head 02 is preferably a component of the first subassembly 46. The positioning drive 38 is preferably a component 38 of the print head unit 34. A positioning spatial area is preferably a spatial area made up of the total of all the spatial areas that can be occupied by the first subassembly 46 along its positioning path. The pivoting space and the positioning space preferably intersect. The mobility and/or movement of the first subassembly 46 is therefore linked to a position and/or movement of the at least one nozzle sealing mechanism 37. Preferably, a movement of the first subassembly 46 permits and/or causes a movement of the at least one nozzle sealing mechanism 37.

In the following, an opening process for the at least one nozzle sealing mechanism 37 will be described. At the start of the opening process, but in particular following an initial movement at the latest, the subassembly 46 is preferably in contact with the at least one nozzle sealing mechanism 37, in particular such that a covering surface 47 of the nozzle sealing mechanism 37 and the nozzle surface 48 of the print head 02 are arranged facing one another with respect to the ejection direction A. The nozzle sealing mechanism 37 is in its closed position. The first subassembly 46 is moved in a positioning direction B by means of the positioning drive 38. The positioning direction B preferably has at least one component that is oriented parallel to the ejection direction A. More preferably, the positioning direction B is parallel to the ejection direction A. The at least one nozzle sealing mechanism 37 is preferably displaced by the subassembly 46 and performs a swerving movement in the form of a pivoting movement about its pivot axis 44. The pivot axis 44 is located, in particular, outside of the area of the positioning space. The movement of the subassembly 46 and preferably the movement of the at least one nozzle sealing mechanism 37 coupled thereto preferably continues at least until all of the straight lines beginning at the nozzle openings and extending linearly in the ejection direction A are pointing past the nozzle sealing mechanism 37. The movement of the first subassembly 46 preferably continues until the first subassembly reaches an end position in which the print head 02 has assumed an operating position relative to the main body 43 of the print head unit 34. The pivoting movement of the nozzle sealing mechanism 37 is preferably carried out counter to the restoring force of the at least one restoring element. Particularly since the movement of the first subassembly 46 effects the movement of the nozzle sealing mechanism 37, the positioning drive 38 is preferably configured to also act as a sealing mechanism drive 38.

In the following, a sealing process for the at least one nozzle sealing mechanism 37 will be described. Once again, the subassembly 46 is preferably initially in contact with the at least one nozzle sealing mechanism 37, in particular such that the covering surface 47 of the nozzle sealing mechanism 37 is facing the subassembly 46 in a direction having at least one component oriented orthogonally to the ejection direction A. The nozzle sealing mechanism 37 is in its open position. The first subassembly 46 is moved opposite the positioning direction B by means of the positioning drive 38. The subassembly 46 gradually opens up the pivoting space and the at least one nozzle sealing mechanism 37 is pivoted about the pivot axis 44, in particular driven by the restoring force of the restoring element. The movement of the subassembly 46 and preferably the movement of the at least one nozzle sealing mechanism 37 coupled thereto is preferably continued at least until the covering surface 47 of the nozzle sealing mechanism 37 and the nozzle surface 48 of the print head 02 are situated facing one another with respect to the ejection direction A.

The first subassembly 46 is also called the print head carriage 46. The equalizing tank 04 is preferably a component of the first subassembly 46. The print head feed line 26 is preferably a component of the first subassembly 46. The first shut-off valve 32 is preferably a component of the first subassembly 46.

At least one sealing element 59 is preferably provided, which ensures that when the nozzle sealing mechanism 37 is in the closed position relative to the print head 02, a first holding space is provided which is sealed except for the nozzle openings and optionally at least one supply opening 61. The at least one supply opening 61 preferably is and/or can be connected to a solvent source. The at least one first holding space preferably serves to create an atmosphere surrounding the nozzle surface and/or the nozzle openings that will protect them from soiling and/or will prevent the coating medium, in particular the ink, from drying out. The at least one nozzle sealing mechanism 37 preferably has at least one storage element 62 for a solvent, in particular different from the coating medium in the reservoir 03, said storage element being embodied, for example, as a container 62 and/or as a sponge 62. The storage element 62 is filled and/or impregnated, for example, with solvent. The solvent is supplied manually and/or automatically, for example. The solvent is supplied, for example, via at least one solvent line 63 and the at least one supply opening 61. Along the solvent line 63, a solvent pump is preferably arranged, which is controlled and/or regulated, for example. In one embodiment, the at least one sealing element 59 is arranged on the subassembly 46. Preferably, however, the at least one sealing element 59 is arranged on the nozzle sealing mechanism 37 and can be moved together with it. The storage element 62 is preferably positioned such that it is spaced at all times from the nozzle surface 47, in particular regardless of whether the at least one nozzle sealing mechanism 37 is in its closed position or in its open position or between these positions.

The subassembly 46 preferably has at least one docking area. The docking area preferably serves as a bearing position for the nozzle sealing mechanism 37 in its open position. The shape of the docking area is preferably adapted to that of the nozzle sealing mechanism 37, in particular such that the nozzle sealing mechanism 37, together with the sealing element 59 and the docking area, forms a second holding space, which is an enclosed space, optionally except for the at least one supply opening 61. The storage element 62 is thereby prevented from drying out during a printing operation.

At least one sensor device 64; 66 for monitoring the status of the at least one storage element 62 and/or the first holding space and/or the second holding space is provided, for example. This sensor device 64; 66 has, for example, at least one temperature sensor and/or at least one sensor 64; 66 for the direct or indirect determination of the solvent concentration in the first holding space and/or in the second holding space. The sensor device 64; 66 includes, for example, at least one first electrode 64 and at least one second electrode 66, spaced from the first. A measurement, for example, of the resistance and/or the conductivity between the two electrodes 64; 66 can then be used to determine the concentration of a medium located between these two electrodes. This medium contains solvents, for example, and/or contains at least one agent for influencing conductivity, e.g. at least one salt, for example, and/or contains at least one agent for reducing an evaporation rate, for example. From this measurement, conclusions can be drawn as to the concentration of the medium within the first holding space or the second holding space.

Medium is preferably replenished in a controlled and/or regulated fashion, in particular as needed, in particular by means of the at least one solvent line 63. The electrodes 64; 66 are in direct contact, for example, with the at least one storage element 62, in particular sponge 62. With corresponding control and/or regulation, for example, a temperature in the region of the electrodes 64; 66 and/or in the region of the storage element 62 can be taken directly into account.

The at least one storage element 62, in particular the at least one sponge 62, is preferably out of contact with the nozzle surface 48 at all times. The nozzle surface 48 is preferably influenced only indirectly by the atmosphere, which is influenced by the medium stored in the storage element 62. This atmosphere can also be controlled and/or regulated, for example, while the printing system 01 is otherwise in a standby mode. This atmosphere can be controlled and/or regulated continuously or at specific intervals, for example.

At least one magnetic element is preferably located on the nozzle sealing mechanism 37 and/or on the subassembly 46. More preferably, at least one magnetic element is located on the nozzle sealing mechanism 37 and at least one magnetic element is located on the subassembly 46. Even more preferably, at least one magnetic element is located on the nozzle sealing mechanism 37 and at least two magnetic elements are located on the subassembly 46, with at least one of the magnetic elements of the subassembly 46 being associated with the nozzle surface 48 and at least one other of the magnetic elements of the subassembly 46 being associated with the docking area. The at least one magnetic element preferably achieves a particularly secure sealing of the first holding space and/or the second holding space.

The printing system 01 preferably comprises at least one fourth pump 49, designated as a filling pump 49. The filling pump 49 is preferably positioned along a refill line 51. The refill line 51 and the filling pump 49 are used in particular for filling the reservoir 03 with coating medium, in particular ink. The filling pump 49 is preferably connected in terms of circuitry to the machine controller, in particular to the fill-level regulating area of the machine controller. The filling pump 49 is preferably a component 49 of the main unit 33. The refill line 51 is preferably a component 51 of the main unit 33. The refill line 51 therefore preferably ends in the storage space 08 of the reservoir 03. The refill line 51 preferably begins at a coating medium inlet 52 or ink inlet 52. The coating medium inlet 52 or ink inlet 52 preferably serves as a connection point for refill container 53. The coating medium inlet 52 or ink inlet 52 is preferably a component 52 of the main unit 33. These refill containers 53 are only temporarily connected to the printing system 01 and in particular form a source for coating medium and in particular ink. After being connected to the coating medium inlet 52 or ink inlet 52, a refill container 53 is preferably first checked to ensure compatibility of its contents with the printing system 01. This is preferably achieved without contact, in particular wirelessly.

The refill container 53 preferably has at least one and more preferably precisely one data module 54, more preferably at least one data module 54 that has at least one transmitting and/or receiving unit for contactless, in particular wireless communication with at least one communications module 56 of the printing system 01. Contactless is understood in particular to mean that there is no physical contact. The at least one data module 54 preferably stores data that can preferably be read out, more preferably wirelessly, by means of the at least one communications module 56 of the printing system 01. The at least one data module 54 is preferably embodied as an RFID module 54 (radio frequency identification module) and/or as an optical data module 54. The at least one data module 54 preferably has at least one data storage device, in particular memory, and at least one transmitting unit, in particular a transmitter, and at least one receiving unit, in particular a receiver. The at least one data module 54 preferably has at least one processor element for processing data. The at least one transmitting unit and the at least one receiving unit are preferably configured as a combined transmitting and/or receiving unit, particularly in the case of an RFID module 54. The at least one transmitting unit and/or the at least one receiving unit and/or the at least one transmitting and/or receiving unit is preferably embodied as at least one antenna, more preferably in the form of at least one conductor loop and even more preferably in the form of at least one conductor coil with a plurality of turns.

The data module 54 is at least readable. Data can thus be transmitted, in particular, from the at least one memory of the at least one data module 54 in a contactless manner, in particular wirelessly, to at least one reading device, for example the at least one communications module 56 of the printing system 01. The data module 54 is preferably writable. Data can thus be transmitted, in particular, by at least one transmitting device, for example the at least one communications module 56 of the printing system 01, in a contactless manner, in particular wirelessly, to the at least one data module 54 and in particular into the at least one memory of the at least one data module, and/or data in the at least one memory of the at least one data module 54 can be updated by means of at least one transmitting device, for example the at least one communications module 56 of the printing system 01. The at least one data module 54 preferably has at least one memory that can be repeatedly rewritten and read out in a contactless fashion. The at least one communications module 56 is preferably a component 56 of the main unit 33.

After the check is performed, in particular, coating medium or ink is conveyed from the refill container 53 via the refill line 51 by means of the filling pump 49. The refill container 53 is preferably emptied completely except for possible adhering residue. In this way, once the refill container 53 has been opened and connected to the coating medium inlet 52 or ink inlet 52, the coating medium, in particular the ink, within the refill container 53, requires no further attention. After being emptied, the refill container 53 can be removed immediately or at a later time, or can be left at the coating medium inlet 52 or ink inlet 52 until another refill container 53 will be connected. The printing system 01 preferably has a second fill-level measuring device 58. The second fill-level measuring device 48 is preferably used to measure a second fill level of coating medium, in particular ink, in the storage space 08 of the reservoir 03. The second fill-level measuring device 58 is preferably a component 58 of the main unit 33. The second fill-level measuring device 58 can preferably detect at least information about a lower indicator level of the reservoir 03 and information about an upper indicator level of the reservoir 03. The lower indicator level of the reservoir 03 corresponds in particular to a lower fill level of the reservoir 03 than the upper indicator level of the reservoir 03. The reservoir 03 preferably holds at least 500 mL and more preferably at least 1000 mL of coating medium, in particular ink. The reservoir 03 preferably holds at most 10 L and more preferably at most 2 L of coating medium, in particular ink.

In one embodiment, the second fill-level measuring device 58 is equipped with a sensor that is suitable for determining whether the fill level of the reservoir 03 has reached the lower indicator level of the reservoir 03 and is also suitable for determining whether the fill level of the reservoir 03 has reached the upper indicator level of the reservoir 03. In a preferred embodiment, the second fill-level measuring device 58 is equipped with a first sensor that is suitable for determining whether the fill level of the reservoir 03 has reached the lower indicator level of the reservoir 03, and the second fill-level measuring device 58 is equipped with a second sensor that is suitable for determining whether the fill level of the reservoir 03 has reached the upper indicator level of the reservoir 03. The second fill-level measuring device 58 is preferably connected in terms of circuitry to the machine controller, in particular to the fill-level regulating area of the machine controller.

The printing system 01 preferably includes at least one stirring device 57. The at least one stirring device 57 preferably keeps the coating medium, in particular ink, within the storage space 08 of the reservoir 03 in motion, or at least places it in motion intermittently. In this way, a settling of pigments can be reduced and/or prevented and/or reversed, for example. At least one stirring magnet 57 or stirring bar 57 is used as the stirring device 57, for example. The at least one stirring device 57 is preferably a component 57 of the main unit 33.

Alternatively or additionally, the printing system 01 is characterized by the fact that a plurality of print heads 02 are connected to the equalizing tank 04 via a common print head feed line 26 or via respective print head feed lines 26. This enables multiple print heads 02 to be operated simultaneously and/or enables larger areas to be printed with the same coating medium, in particular ink, per unit of time.

In the above, the printing system 01 has been described as having a system of lines for a coating medium, in particular an ink. In one embodiment, the printing system 01 is configured for multi-color printing. In that case, the printing system is preferably alternatively or additionally characterized by the fact that it comprises a reservoir and/or an equalizing tank 04 and/or at least one print head 02 and/or at least one first pump 09 or liquid pump 09 and/or at least one first fill-level measuring device 42 and/or a gas supply pump 13 and/or a gas removal pump 17 and/or at least one first pressure sensor 39 and/or at least one second pressure sensor 41 for each coating medium.

While preferred embodiments of a printing system, in accordance with the present invention, have been set forth fully and completely hereinabove, it will be apparent to one of skill in the art that various changes could be made thereto without departing from the true spirit and scope of the present invention which is accordingly to be limited only by the appended claims.

1-30. (canceled)

31. A printing system (01), wherein the printing system (01) has at least one reservoir (03) for coating medium and an equalizing tank (04) and at least one print head (02), and wherein the printing system (01) has a main unit (33) and a print head unit (34), and wherein the reservoir (03) is a component of the main unit (33), and wherein the print head unit (34) is connected to the main unit (33) by at least one flexible supply connection (36), and wherein the print head unit (34) as a whole can be arranged in different printing positions relative to the main unit (33), each of which permits regular printing operation of the printing system (01), while maintaining the position of the components of the print head unit (34) relative to one another, and wherein the print head unit (34) has at least one main body (43) and the at least one print head (02) and at least one nozzle sealing mechanism (37), and wherein the at least one nozzle sealing mechanism (37) and the at least one print head (02) are movable relative to one another, and wherein the nozzle sealing mechanism (37) has at least one storage element (62) for solvent, which is different from the coating medium held in the reservoir (03).

32. The printing system according to claim 31, characterized in that the print head unit (34) as a whole can be arranged in at least three different printing positions relative to the main unit (33) that differ from one another at least with respect to the ejection direction of nozzles of the at least one print head (02) and with respect to the difference between the height of the lowest point on the bottom of the reservoir (03) and the height of the highest nozzle opening of the at least one print head (02).

33. The printing system according to claim 31, characterized in that the at least one nozzle sealing mechanism (37) is movable and/or pivotable relative to the main body (43), and/or in that at least one solvent line (63) is connected to the nozzle sealing mechanism (37), and/or in that the nozzle sealing mechanism (37) has at least one sealing element (59), and/or in that the at least one nozzle sealing mechanism (37) is movable and/or pivotable relative to the main body (43) between at least one closed position and at least one open position, and/or in that the only component of the printing system (01) that connects the print head unit (34) to the main unit (33) is the at least one flexible supply connection (36).

34. The printing system according to claim 31, characterized in that the print head unit (34) has at least one first subassembly (46) that is movable relative to the main body (43) and the at least one print head (02) is a component of the first subassembly (46).

35. The printing system according to claim 31, characterized in that the at least one print head (02) is configured as an inkjet print head (02) and/or in that the at least one print head (02) is configured as at least one print head (02) that remains stationary during a printing operation.

36. The printing system according to claim 31, characterized in that at least one sensor device (64; 66) is positioned for monitoring a state of the at least one storage element (62) and/or of a first holding space and/or of a second holding space, and/or the at least one storage element (62) is out of contact with the nozzle surface (48) of the print head (02) at all times.

37. The printing system according to claim 36, characterized in that the sensor device (64; 66) has at least one first electrode (64) and at least one second electrode (66), spaced from the first, and/or the sensor device (64; 66) has at least one first electrode (64) and at least one second electrode (66), spaced from the first, and the electrodes (64; 66) are in direct contact with the at least one storage element (62) and/or sponge (62).

38. The printing system according to claim 31, characterized in that the at least one print head (02) is fluidically connected to the equalizing tank (04) via at least one print head feed line (26), and in that the printing system (01) has at least one supply line (06), which extends from the reservoir (03) to the equalizing tank (04), and in that at least one first pump (09) is positioned along the at least one supply line (06), and in that the printing system (01) has a second pump (13) configured as a gas supply pump (13), and in that a line volume bordering a pump outlet (16) of the second pump (13) passes into an interior chamber (07) of the equalizing tank (04), and in that the printing system (01) has a third pump (17) configured as a gas removal pump (17), and in that a line volume bordering a pump inlet (18) of the third pump (17) passes into the interior chamber (07) of the equalizing tank (04).

39. The printing system according to claim 38, characterized in that the first pump (09) is embodied as a diaphragm pump (09) and/or in that the gas supply pump (13) is embodied as a diaphragm pump (13) and/or that the gas removal pump (17) is embodied as a diaphragm pump (17).

40. The printing system according to claim 31, characterized in that the at least one print head (02) is fluidically connected to the equalizing tank (04) via at least one print head feed line (26), and in that at least three pumps (09; 13; 17) embodied as diaphragm pumps (09; 13; 17) are provided, the respective pump inlets (18) or pump outlets (12; 16) of which, at least during a printing operation, are fluidically connected without interruption to an interior chamber (07) of said equalizing tank (04).

41. The printing system according to claim 31, characterized in that the at least one print head (02) is fluidically connected to the equalizing tank (04) via at least one print head feed line (26), and in that the printing system (01) has at least one supply line (06), which extends from the reservoir (03) to the equalizing tank (04), and in that at least one first pressure sensor (39) is positioned so as to measure and/or be capable of measuring a pressure corresponding to the pressure within the equalizing tank (04), and in that at least one fill-level measuring device (42) is positioned so as to measure and/or be capable of measuring a fill level of coating medium in an interior chamber (07) of the equalizing tank (04).

42. The printing system according to claim 31, characterized in that the printing system (01) has at least one supply line (06), which extends from the reservoir (03) to the equalizing tank (04), and at least one first pump (09) embodied as a diaphragm pump (09) is positioned along the at least one supply line (06), and/or in that the printing system (01) has a second pump (13) embodied as a diaphragm pump (13), which is configured as a gas supply pump (13), and a line volume bordering a pump outlet (16) of the second pump (13) passes into the interior chamber (07) of the equalizing tank (04), and/or in that the printing system (01) has a third pump (17) embodied as a diaphragm pump (17), which is configured as a gas removal pump (17), and a line volume bordering a pump inlet (18) of the third pump (17) passes into the interior chamber (07) of the equalizing tank (04).

43. The printing system according to claim 38, characterized in that the line volume bordering the pump outlet (16) of the second pump (13) passes fluidically without interruption, at least during a printing operation, into the interior chamber (07) of the equalizing tank (04), and in that the line volume bordering a pump inlet (18) of the third pump (17) passes fluidically without interruption, at least during the printing operation, into the interior chamber (07) of the equalizing tank (04).

44. The printing system according to claim 38, characterized in that the first pump (09) and/or the gas supply pump (13) and/or the gas removal pump (17) is/are configured as a component (09; 13; 17) of the main unit (33), and/or in that the at least three pumps (09; 13; 17) embodied as diaphragm pumps (09; 13; 17) are each configured as components (09; 13; 17) of the main unit (33).

45. The printing system according to claim 31, characterized in that the at least one supply connection (36) is embodied as at least one tube (36), and/or in that at least parts of the supply line (06) and at least parts of a gas supply line (21) and/or a gas removal line (22) and/or a gas equalization line (23) are located in the at least one supply connection (36), and/or in that at least parts of at least one power supply line and/or at least parts of at least one data supply line are located in the at least one supply connection (36).
